(19) United States
(12) Patent Application Publication
(10) Pub. No.: US 2017/0117548 A1
(43) Pub. Date: Apr. 27, 2017

(54) Electrode Material for an Electrochemical Storage System, Method for the Production of an Electrode Material and Electrochemical Energy Storage System

(71) Applicant: Daimler AG, Stuttgart (DE)

(72) Inventor: Andreas HINTENNACH, Tamm (DE)

(73) Assignee: Daimler AG, Stuttgart (DE)

(21) Appl. No.: 15/317,727

(22) PCT Filed: May 19, 2015
(86) PCT No.: PCT/EP2015/001021

§ 371 Date: Dec. 9, 2016

(30) Foreign Application Priority Data
Jun. 12, 2014 (DE) 10 2014 009 554.1

(51) Int. Cl. H01M 4/62; H01M 4/58; H01M 4/38; H01M 10/0525; H01M 4/40

(52) U.S. Cl. CPC H01M 4/625; H01M 10/0525; H01M 4/405; H01M 4/382; H01M 4/5815; H01M 2004/021

(57) ABSTRACT

An electrode material for an electrochemical energy storage system is disclosed. The electrode material is formed from a composite material where the composite material includes at least one electrically conductive matrix and an active material. The electrically conductive matrix includes at least one porous and mechanically flexible carbon structure. A method for the production of an electrode material and an electrochemical energy storage system are also disclosed.

### BACKGROUND AND SUMMARY OF THE INVENTION

The invention relates to an electrode material for an electrochemical storage system. The invention furthermore relates to a method for the production of an electrode material and an electrochemical energy storage system.

A solid composite material is described in US 2013/0164635 A1 which is used for a cathode of a lithium-sulphur battery cell, wherein the composite material comprises 1 to 75% b.w. expanded graphite, 25 to 29% b.w. sulphur, zero to 50% b.w. of a further conductive material or several further conductive materials and zero to 50% b.w. of a binding agent or several binding agents. The lithium-sulphur battery cell furthermore comprises an anode and an electrolyte which is arranged between the anode and the cathode.

The object of the invention is to specify an electrode material for an electrochemical energy storage system which is improved compared to the prior art, an improved method for the production of an electrode material and an improved electrochemical energy storage system.

An electrode material for an electrochemical energy storage system is formed from a composite material, wherein the composite material comprises at least one electrically conductive matrix and an active material. According to the invention, it is provided that the electrically conductive matrix comprises at least one porous and mechanically flexible carbon structure.

The electrode material formed in such a way is suitable in particular for lithium-ion or metal-sulphur or metal-air batteries, wherein a change in volume caused by charging and discharging by depositing or removing the active material of the electrode, in particular the anode, can be absorbed by means of the porous and mechanically flexible carbon compound in a manner that is as free from damage as possible and without incurring any loss of the electrical contacting of the electrodes. In addition, an active material stored in the cathode is thus, in particular, able to be absorbed in an irreversible manner such that a diffusion of the cathodic active material to the anode can be prevented and at least reduced and as a result the life span of the battery is significantly improved compared to the prior art.

A volume of the electrically conductive matrix can preferably be changed by the mechanically flexible formation of the electrically conductive matrix, in particular the carbon structure, depending on an oxidization process and/or reduction process of the active material. This means, for example, that during a charging process of the battery, the active material intercalated in an anode, for example, lithium in lithium ions and electrons, is oxidized. The lithium ions then travel through an ion conducting separator to the cathode. At the cathode, the lithium ions are absorbed by a reduction reaction, wherein the active material of the cathode is reduced, for example sulphur into lithium sulphide. Here, less active material is embedded in the electrically conductive matrix of the anode than in the cathode, such that the electrically conductive matrix of the anode has a lower volume than when charging the battery, wherein the active material, for example lithium cations, travels back to the anode. The volume of the electrically conductive matrix of the anode is thus increased again. The same applies for the cathode. This is also known as electrode “breathing”. This mechanical flexibility makes it possible to compensate for the specified volumetric changes of the electrode, such that a mechanical load on the electrode is reduced compared to the prior art. A pore size of the carbon structure can vary from a micro level via a meso level to a macro level.

Here, the composite material is formed as a coating material for a cathode, wherein the electrically conductive matrix is formed from graphite, for example, which has good electrical conductivity as well as high corrosion resistance.

Alternatively, the composite material is formed as a coating material for an anode, wherein the electrically conductive matrix additionally comprises a silicon structure. Compared to graphite, silicon has a reduced level of electrical conductivity, but has the property of intercalating a larger amount of active material, in particular metal ions such as lithium ions, and is therefore particularly suitable for coating the anode.

A method according to the invention is provided for the production of the electrode material described above, the method comprising the following steps:

a) preparing a number of raw materials for the production of the electrically conductive matrix,

b) mixing and pressing the raw materials into a tablet,

c) immersing the tablet in a solvent,

d) irradiating the tablet with electromagnetic radio-frequency radiation,

e) pulverizing the irradiated tablet and subsequently immersing the powder in a further solvent,

f) creating a mixture from the powder immersed in the further solvent and an active material,

g) heating the mixture to a predetermined temperature and then stirring the heated mixture,

h) cooling the stirred, heated mixture,

i) irradiating the cooled mixture with electromagnetic radio-frequency radiation and,

j) cooling and pulverizing the irradiated mixture.

The method enables the production of a porous and mechanically flexible electrode material which can be applied to an electrode as a coating in a solvent-free manner. No drying processes are required for the electrode material, which means that energy can be saved. In addition, exhaust air purification is not required as a result of there being no drying process, which means that energy usage is further optimized. There is also no solvent purification, which means that the time and money spent on the production process can be reduced compared to the prior art. The total sum of carbon dioxide emissions is also reduced compared to using a solvent.

Particularly preferably, electromagnetic radio-frequency radiation used for the production of the electrode material according to method step d) and i) is emitted substantially continuously. This is possible by means of a modified microwave oven which, compared to generally known microwave ovens, comprises a second high-voltage transformer and additionally two high-voltage capacitors and four high-voltage diodes. The continuously emitted radiation causes pyrolysis or partial pyrolysis of organic compounds in the electrically conductive matrix, whereby porosity and mechanical flexibility of the electrically conductive matrix are achieved.

The silicon is thus added to the electrically conductive matrix in addition to the raw materials, wherein at least one carbohydrate, potassium bicarbonate and magnesium stearate are provided according to a preferred exemplary embodiment.

Furthermore, the invention relates to an electrochemical energy storage system having at least one electrode, comprising an electrode material which is described above.

Exemplary embodiments of the invention are illustrated in greater detail below by means of the drawings.

### BRIEF DESCRIPTION OF THE DRAWINGS

FIG. 1 schematically illustrates an exploded depiction of a single cell for a battery,

FIG. 2 illustrates a method sequence diagram for a method for the production of an electrode material for a cathode, and

FIG. 3 schematically illustrates an electrical circuit of power electronics of a microwave oven for the irradiation of an electrode material during the production of the electrode material.

### DETAILED DESCRIPTION OF THE DRAWINGS

Parts that correspond to one another are provided with the same reference numerals in all figures.

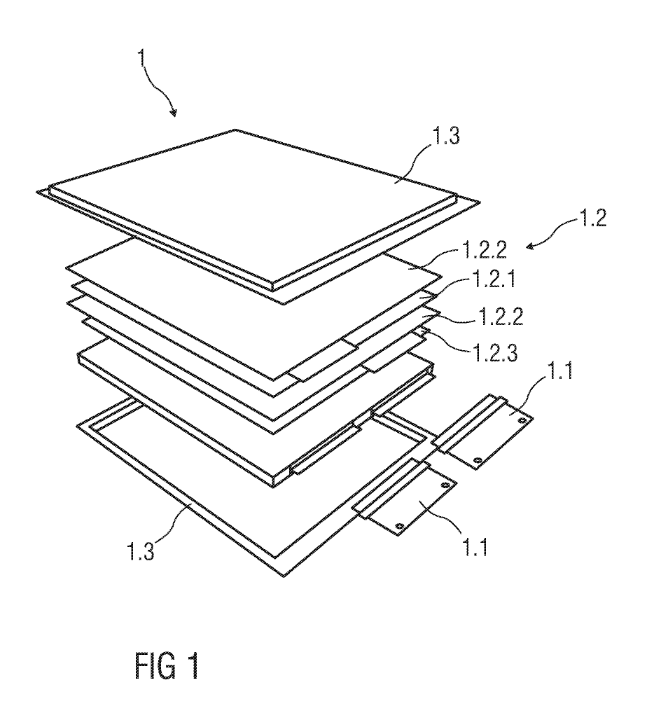

In FIG. 1, a single cell 1 for a battery which is not depicted in more detail is shown. In particular, the battery is a rechargeable battery, for example a lithium-sulphur battery.

The single cell 1 is a so-called pouch or coffee bag cell, wherein a number of such single cells 1 are connected electrically in series and/or in parallel with one another to form the battery and wherein interconnection takes place via plate-like arresters 1.1 as electrical connections of the single cell 1.

Such a single cell 1 is implemented as a flat and as rectangular as possible storage system element for electrical energy which comprises an electrode foil arrangement 1.2 made from layers of several alternately stacked, foil-like anodes 1.2.1, separators 1.2.2 and cathodes 1.2.3 which is surrounded by a foil-like casing 1.3 which is formed from two shell-like foil sections.

Here, the anode 1.2.1 is formed as a negative electrode and the cathode 1.2.3 is formed as a positive electrode. The anode 1.2.1 and the cathode 1.2.3 are referred to below as electrodes.

The electrodes of the single cell 1 are each formed from a substrate and are coated with the electrically conductive matrix in which an active material is contained in a defined manner. Here, the electrodes are formed as solid bodies, wherein the battery can preferably also be used for high temperature ranges and thus as a high-temperature battery.

The electrically conductive matrix for the cathode 1.2.3 is formed from an electrically conductive carbon structure such as, for example, graphite or carbon black. The electrically conductive matrix for the anode 1.2.1 is formed from an electrically conductive carbon structure and a silicon structure since silicon has a less favorable level of electrical conductivity than carbon but can bind a larger quantity of active material.

The active material can be bound in the electrically conductive matrix homogeneously over the complete electrode. The active material serves for a chemical reaction taking place between the anode 1.2.1 and the cathode 1.2.3, in particular when charging and discharging the battery. If the battery is formed as a lithium-sulphur battery, then the active material is, for example, sulphur for the cathode 1.2.3 and lithium or a lithium alloy for the anode 1.2.1.

When discharging the battery, the lithium intercalated in the anode 1.2.1 is oxidized into lithium ions and electrons. The lithium ions travel through the ion-conducting separator 1.2.2 to the cathode 1.2.3, while at the same time the electrons are transferred via an outer circuit from the anode 1.2.1 to the cathode 1.2.3, wherein an energy consumer can be interconnected between the cathode 1.2.3 and the anode 1.2.1, the energy consumer being supplied with energy by the electron flow. At the cathode 1.2.3, the lithium ions are absorbed by a reduction reaction, wherein sulphur is reduced to lithium sulphide.

The electrochemical reaction when discharging a battery is generally known and can, with the example of a lithium-sulphur battery, be described as follows:

Anode 1.2.1: Li→Li⁺+e⁻;

Cathode 1.2.3: S₈+2Li⁺+e⁻→Li₂S₈→Li₂S₆→Li₂S₄→Li₂S₂→Li₂S

When charging the battery, an energy source is connected to the electrodes. The lithium is thus oxidized from lithium sulphide to lithium cations, wherein the lithium cations travel via the separator 1.2.2 and the electrons via the outer circuit back to the anode 1.2.1.

When discharging the battery, polysulphides also arise which are potentially not completely converted into elemental sulphur during the charging process. These polysulphides may travel via the separator 1.2.2 to the anode 1.2.1 and form a lithium-sulphide layer there which considerably reduces the capacity and therefore the life span of the battery. In addition, the active material embedded in the electrically conductive matrix of the cathode 1.2.3 is gradually reduced.

In addition, it is known that the volumes of electrodes change during charging and discharging. This leads to mechanical loads on the electrodes which can lead to a loss of power of the battery. A loss of electrical contact of the electrode can also take place.

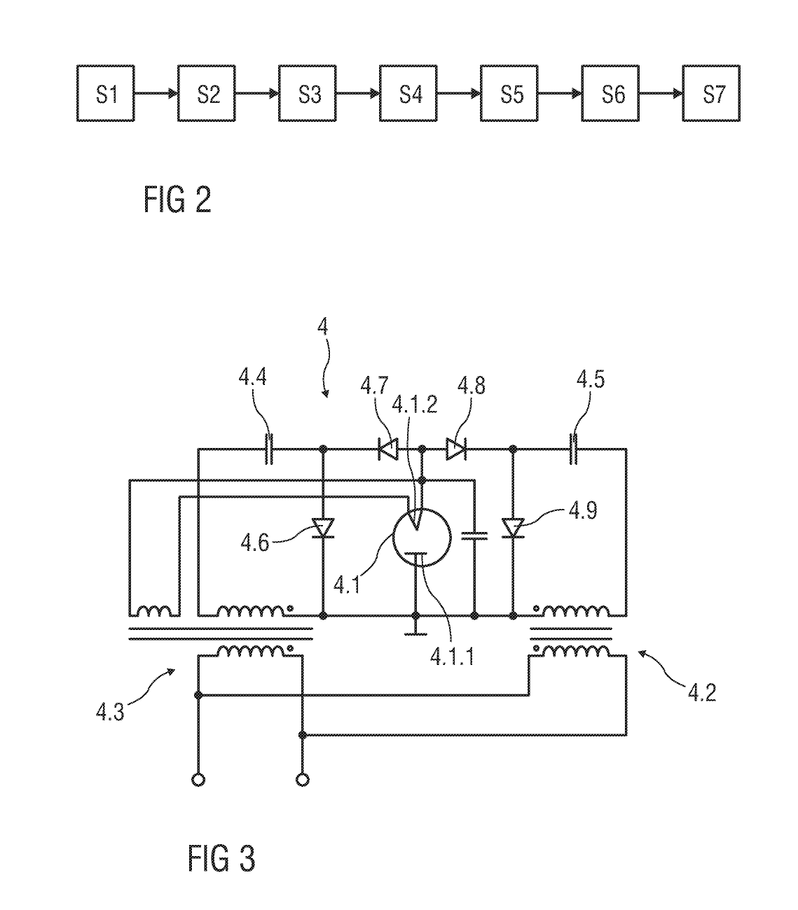

In order to solve the problem, the invention provides the formation of the electrically conductive matrix as a porous and mechanically flexible carbon compound, wherein a method for the production of an electrode material for a cathode 1.2.3 with such a carbon structure which is formed to be porous and mechanically flexible is described in more detail in FIG. 2.

The active material is intercalated in the pores of the electrically conductive matrix, wherein the pores are not depicted here in more detail. Here, in the charged state of the single cell 1, a volumetric expansion of the electrically conductive matrix compared to the prior art is possible.

In the discharged state, the active material of the cathode is reduced to lithium sulphide and almost completely fills the volumetrically increased free space in the carbon structure. The electrically conductive matrix therefore expands corresponding to the increased amount of active material, in this case, lithium sulphide. Since there is less active material in the anode in the discharged state, in this case lithium ions, the electrically conductive matrix adjusts its expansion corresponding to the number of lithium ions.

Due to the fact that the volume of the electrically conductive matrix changes depending on the amount of active material embedded in the carbon structure and therefore also a respective pore size of the carbon structure, the risk of polysulphides leaving the electrically conductive matrix of the cathode during the charging process is significantly reduced compared to prior art.

A method according to the invention for the production of such an electrode material for a cathode is described below.

For this purpose, FIG. 2 shows a method sequence diagram with seven method steps S1 to S7.

In a first method step S1, carbohydrates, for example sucrose, potassium bicarbonate, magnesium stearate and stearic acid, are provided and mixed together for the production of the carbon structure for the electrically conductive matrix of a cathode 1.2.3. The aforementioned components are then pulverized and pressed into a tablet, wherein the dimensions of the tablet are predetermined on the basis of the ratio between surface and volume.

In a second method step S2, the tablet is immersed in a solvent, for example a mixture of ethanol and acetylacetone, wherein the solvent preferably only penetrates the tablet on the surface.

In a third method step S3, the tablet which is immersed in solvent is continuously irradiated with electromagnetic radiation in the gigahertz range in five steps according to a predetermined protocol, i.e., predetermined irradiation times for corresponding performance regulations. This takes place with the aid of a microwave oven 4, the power electronics of which are depicted in more detail in FIG. 3 in the form of a circuit diagram.

A partial pyrolysis of the tablet takes place during irradiation, wherein the carbon compounds of the carbon structure are partially thermochemically split. Highly porous carbon compounds are thereby formed in a controlled manner.

In a fourth method step S4, the partially pyrolysed carbon compound is pulverized again, immersed in a solvent and mixed with an active material, for example sulphur powder.

In a fifth method step S5, the carbon compound mixed with the active material is heated in a closed vessel to a predetermined temperature, wherein the active material changes from a solid to a liquid physical state, i.e., the active material melts. The temperature is kept constant for a predetermined period of time. Heating the carbon structure mixed with the active material can take place by means of the microwave oven 4.

In a sixth method step S6, the melted active material and the carbon structure are mixed together with continuously emitted ultrasound waves until the temperature of the mixture has cooled to a predetermined temperature.

In a seventh method step S7, the cooled mixture is irradiated again by means of the microwave oven 4 with electromagnetic radiation in two stages according to a predetermined heating protocol, for example with a radiation power between 250 watts and 1000 watts, whereby a permanent, secure and, in particular, substantially irreversible absorption of the active material in the carbon structure is ensured. The mixed and irradiated mixture is then cooled to a predetermined temperature and pulverized.

The production of an electrode material for an anode 1.2.1 takes place in a similar manner to the method described above. Here, silicon is additionally added, for example, to the carbon structure, such that the electrically conductive matrix comprises a porous and mechanically flexible carbon structure and silicon structure. For example, lithium is intercalated in the electrically conductive matrix as an active material. Here, the intercalation of lithium takes place in similar manner to the intercalation of sulphur in the electrically conductive matrix described above according to the fourth to seventh method steps S4 to S7. Alternatively, for example, sodium can be used as active material for the anode 1.2.1.

FIG. 3 shows an electrical circuit of the microwave oven 4 in the form of a circuit diagram, wherein the circuit diagram only shows a part of the electrical circuit of the microwave oven 4, in particular power electronics.

The microwave oven 4 comprises a magnetron 4.1 having a positively charged electrode 4.1.1 and a negatively charged electrode 4.1.2.

The positively charged electrode 4.1.1 is connected to a ground potential such that the negatively charged electrode 4.1.2 has a negative voltage with respect to the ground potential.

In order to operate the magnetron 4.1 which generates electromagnetic high-frequency waves, the magnetron 4.1 is coupled to two high-voltage transformers 4.2, 4.3 which each increase an alternating voltage, in particular mains voltage, applied to a first coil, to a predetermined level in a second coil, in particular to a level in the high-voltage range.

The alternating high voltages generated in this way are each divided, rectified and applied to the negatively charged electrode 4.1.2 of the magnetron 4.1 by means of a high-voltage capacitor 4.4, 4.5 and a bridge rectifier circuit, each comprising two high-voltage diodes 4.6 to 4.9 connected in parallel to each other.

The rectified high voltages applied to the negatively charged electrode 4.1.2 thus each alternate periodically with a predetermined frequency between zero volts and a predetermined high voltage for operating the magnetron 4.1. A predetermined threshold voltage is thus allocated to the magnetron 4.1. If the high voltage applied to the magnetron 4.1 is greater than the threshold voltage, then a current flows through the magnetron 4.1 for a short period.

The microwave oven 4 described here is characterised in particular by a second high-voltage transformer 4.3 of the two high-voltage capacitors 4.4, 4.5 and the bridge rectifier circuit, by means of which continuously emitted radio-frequency radiation is possible. For this purpose, the high voltages applied to the magnetron 4.1 exceed the threshold voltage alternately such that a current flows through the magnetron 4.1 continuously.

The continuous irradiation of the electrode material thereby causes a desired partial pyrolysis of the carbon structure and in particular of the silicon structure during the production of the electrode material for the anode 1.2.1.

1.-9. (canceled)

10. An electrode material for an electrochemical energy storage system, comprising:
a composite material, wherein the composite material includes an electrically conductive matrix and an active material;
wherein the electrically conductive matrix comprises a porous and mechanically flexible carbon structure.

11. The electrode material according to claim 10, wherein a volume of the electrically conductive matrix is changeable depending on an oxidization process and/or a reduction process of the active material.

12. The electrode material according to claim 10, wherein the composite material is a coating material for a cathode and wherein the electrically conductive matrix is formed from graphite.

13. The electrode material according to claim 10, wherein the composite material is a coating material for an anode and wherein the electrically conductive matrix comprises a silicon structure.

14. A method for production of an electrode material according to claim 10, comprising the steps of:
a) preparing a plurality of raw materials for production of the electrically conductive matrix;
b) mixing and pressing the plurality of raw materials into a tablet;
c) immersing the tablet in a solvent;
d) irradiating the tablet with electromagnetic radio-frequency radiation;
e) pulverizing the irradiated tablet into a powder and subsequently immersing the powder in a further solvent;
f) creating a mixture from the powder immersed in the further solvent and an active material;
g) heating the mixture to a predetermined temperature and then stirring the heated mixture;
h) cooling the stirred, heated mixture;
i) irradiating the cooled mixture with electromagnetic radio-frequency radiation; and
j) cooling and pulverizing the irradiated mixture.

15. The method according to claim 14, wherein the electromagnetic radio-frequency radiation is emitted substantially continuously.

16. The method according to claim 14, wherein the plurality of raw materials includes a carbohydrate, a potassium bicarbonate and magnesium stearate.

17. The method according to claim 14, wherein silicon is added to the electrically conductive matrix.

18. An electrochemical energy storage system, comprising an electrode having an electrode material according to claim 10.
